(19) United States
(12) Patent Application Publication
(10) Pub. No.: US 2025/0347150 A1
(43) Pub. Date: Nov. 13, 2025

(54) Swing handle arrangement with a locking function

(71) Applicant: ABLOY OY, Joensuu (FI)

(72) Inventors: Ville HEISKANEN, Kontiolahti (FI); Juha RAATIKAINEN, Kontiolahti (FI); Tommi HASSINEN, Joensuu (FI); Mika RYHÄNEN, Joensuu (FI)

(21) Appl. No.: 18/867,791

(22) PCT Filed: Apr. 13, 2023
(86) PCT No.: PCT/FI2023/050207

§ 371 Date: Nov. 20, 2024

(30) Foreign Application Priority Data
May 23, 2022 (FI) 20225451

(51) Int. Cl. E05B 47/06; E05B 1/00; E05B 47/00

(52) U.S. Cl. CPC E05B 47/0661; E05B 1/0092; E05B 47/0012

(57) ABSTRACT

A swing handle arrangement having a locking function includes a swing handle, a frame, and a spindle arrangement. The swing handle is pivoted to the spindle arrangement, and the spindle arrangement is pivoted to the frame. The swing handle arrangement also includes an electric actuator, a shaft arrangement for the electric actuator, and a latch arranged in the frame. The swing handle further includes a latching surface. The latch is arranged to be against the latching surface of the swing handle in the locking position of the swing handle. The latch and the latching surface are thus arranged to lock the swing handle arrangement, which can be unlocked by means of the electric actuator via the shaft arrangement for the electric actuator.

### FIELD OF INVENTION

The invention relates to a swing handle arrangement with a locking function. The swing handle arrangement is normally used in various cabinet doors or hatches.

### PRIOR ART

In various cabinet doors or hatches, a swing handle is often used for opening the door or hatch. A swing handle may be used in a normal door as well. In the closed position of the door or hatch, the swing handle is against the frame of the swing handle arrangement. Thus, the swing handle is not exposed for turning. For opening the door or hatch, the swing handle is taken out from the frame, whereby the swing handle can be turned for opening the door or hatch. Thus, in the present specification, the swing handle refers to this type of a swing handle. The swing handle arrangement may also comprise a locking function. In such a case, it is not possible to take out the swing handle from the frame and/or to open the door or hatch with the swing handle.

EP 3628802 presents a prior art swing handle arrangement with a locking function. In this arrangement, an electric motor is used for releasing a latch from its latching position, whereby the swing handle can be taken out from the frame of the arrangement. The arrangement also comprises a locking element for preventing a spindle from being turned. The same electric motor also controls the latch.

The solutions of prior art are workable as such, even though problems may be involved in their functionality. For example, the door or hatch is always locked when the swing handle is against the frame of the swing handle arrangement, which may be unnecessary, for example, during daytime.

### BRIEF DESCRIPTION OF THE INVENTION

It is an aim of the invention to provide an alternative implementation in relation to the implementations of prior art. This is achieved in the way presented in the independent claim. The dependent claims describe various embodiments of the invention.

The swing handle arrangement according to the invention comprises a locking function. The arrangement comprises a swing handle 1, a frame 2, and a spindle arrangement 3. The swing handle is connected to the spindle arrangement in a pivotable manner, and the spindle arrangement is connected to the frame in a pivotable manner. The swing handle arrangement also comprises an electric actuator 4 arranged in the frame 2, a shaft arrangement 5 for the electric actuator, and a latch 6. The swing handle also comprises a latching surface 7. The latch 6 is arranged to be against the latching surface of the swing handle when the swing handle is its locked position. The latch 6 and the latching surface 7 are thus arranged to constitute the locking of the swing handle arrangement, which is releasable by the electric actuator 4 via the shaft arrangement 5 for the electric actuator.

The swing handle arrangement further comprises a second shaft 8 with a cam 9, and wherein the latch is provided with a groove 10. In the locking position of the swing handle arrangement, the cam 9 is in the groove, preventing a linear movement of the latch away from the latching surface 7 of the swing handle. The locking can be unlocked by the electric actuator 4 via the shaft arrangement 5 for the electric actuator, by turning the second shaft 8 so that the cam 9 moves out of the groove 10.

### LIST OF FIGURES

In the following, the invention will be described in more detail with reference to the figures in the appended drawings, wherein

FIG. 1 shows an example of an installed swing handle arrangement according to the invention,

FIG. 2 shows an example of a swing handle arrangement according to the invention.

FIG. 3 shows an example of an assembly according to the invention,

FIG. 4 shows an example of structures of the invention when the arrangement is in the locking position,

FIG. 5 shows an example of structures of the invention in an unlocked position, controlled by an electric actuator,

FIG. 6 shows another example of structures of the invention when the arrangement is in the locking position,

FIG. 7 shows an example of structures of the invention when the arrangement is in an unlocked position, controlled by a lock cylinder,

FIG. 8 shows an example of a detail of the invention,

FIG. 9 shows an example of a locking element,

FIG. 10 shows an example of the locking element in its latching position,

FIG. 11 shows a cross-sectional view of the locking element,

FIG. 12 shows another cross-sectional view of the locking element, and

FIG. 13 shows a cross-sectional view of the locking element in its latching position.

### DESCRIPTION OF THE INVENTION

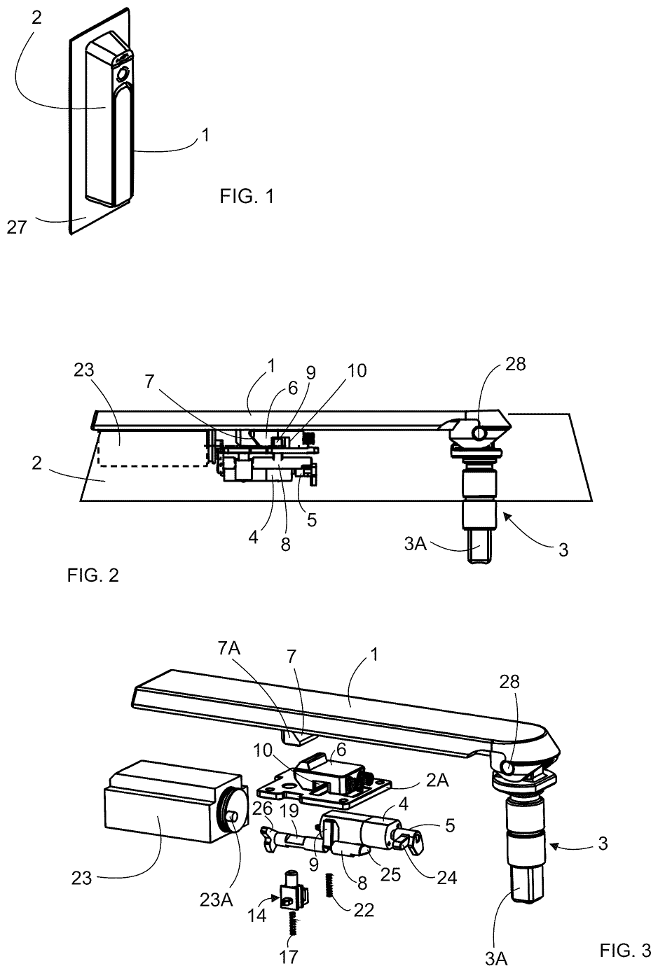

FIG. 1 shows an example of a swing handle arrangement according to the invention, comprising a locking function. The arrangement comprises a swing handle 1, a frame 2, and a spindle arrangement 3. The spindle arrangement is shown in FIG. 2. The swing handle arrangement is used in doors and hatches. In many cases, a swing handle is used in doors of various cabinets, or hatches 27. FIG. 1 shows a part of a cabinet door or hatch 27. In FIG. 1, the swing handle is placed against the frame 2 of the swing handle arrangement. For opening the door or hatch, the swing handle is turned out from the frame, whereby the swing handle can be turned for opening the door or hatch. Normally, the swing handle has a design facilitating the turning out of the swing handle. In this embodiment, the swing handle extends slightly beyond the lower edge of the frame at the lower end of the frame 2, as shown in FIG. 2.

The swing handle is connected to the spindle arrangement 3 in a pivotable manner, and the spindle arrangement is connected to to the frame 2 in a pivotable manner. This is illustrated in FIG. 2. The attachment to the spindle arrangement 3 can be implemented by means of, for example, a fastening pin 28, whereby the fastening pin constitutes a pivot axis, and the swing handle 1 can be turned out of the frame and back to the frame with respect to the pivot axis. The spindle arrangement 3 comprises a spindle 3A communicating with the opposite side of the door or hatch. The spindle can be provided with a latch element for keeping the door or hatch closed.

The swing handle arrangement also comprises an electric actuator 4 arranged in the frame 2, a shaft arrangement 5 for the electric actuator, and a latch 6. The swing handle also comprises a latching surface 7. The latch 6 is arranged to be against the latching surface of the swing handle when the swing handle is its locking position. The latch 6 and the latching surface 7 are thus arranged to constitute the locking of the swing handle arrangement, which is releasable by the electric actuator 4 via the shaft arrangement 5 for the electric actuator.

The swing handle arrangement further comprises a second shaft 8 with a cam 9, and the latch comprises a groove 10. In the locking position of the swing handle arrangement, the cam 9 is in the groove, preventing a linear movement of the latch away from the latching surface 7 of the swing handle. This situation is shown in FIG. 2. The locking can be unlocked by the electric actuator 4 via the shaft arrangement 5 for the electric actuator, by turning the second shaft 8 so that the cam 9 moves out of the groove 10.

It is also possible to provide an embodiment of the invention comprising a lock cylinder 23 in addition to the electric actuator 4. Thus, the locking can be unlocked by the electric actuator as well as the lock cylinder. The lock cylinder may be operated with a key, electrically, or in both ways.

FIG. 3 shows parts of the invention in more detail in an exploded view. The latching surface 7 of the swing handle 1 is implemented on a protrusion 7A. The frame 2 comprises various structures which are not explained in more detail in this specification, because they are not needed as such for describing the invention. The frame and its structures can be implemented in a variety of ways, according to the use. FIG. 3 shows an example where the frame structure is a plate 2A. The plate is placed between the latch 6 and the second shaft 8, and it is provided with the necessary shapes and through holes for the fastening, for the locking element 14 and for the shape of the second shaft.

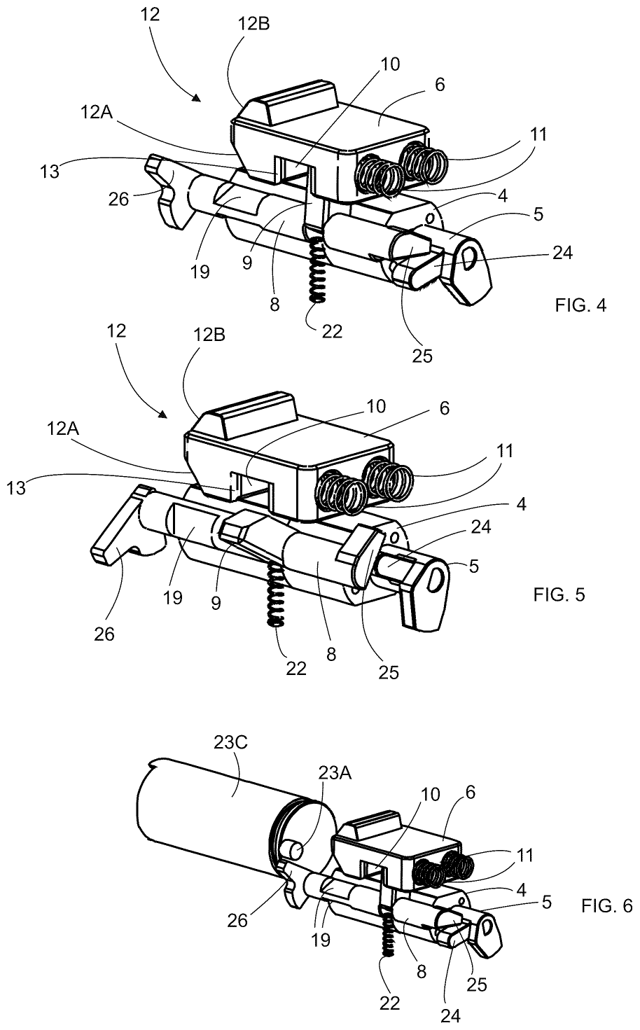

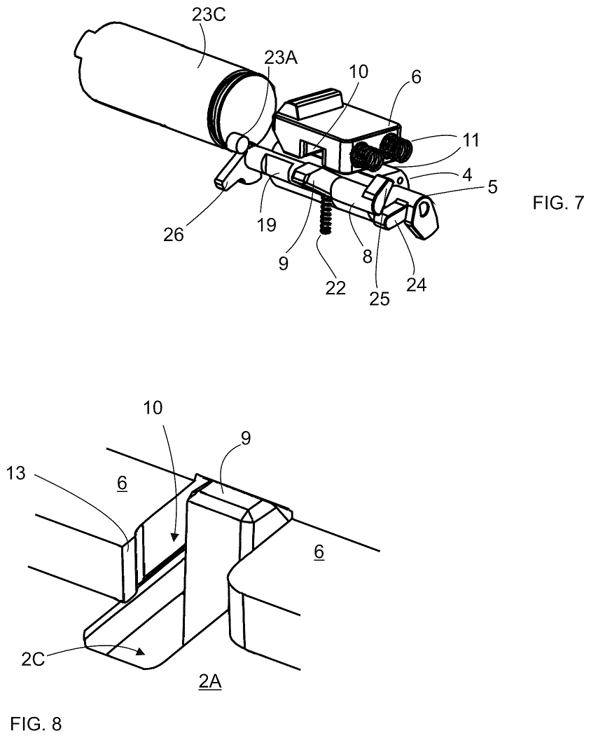

FIGS. 4 and 5 show how the swing handle arrangement can be unlocked with the electric actuator 4. FIGS. 6 and 7 show how the swing handle arrangement can be unlocked with a lock cylinder 23, 23C. As shown in the figures, the swing handle arrangement comprises a spring arrangement 11 for pushing the latch 6 in a direction opposite to the above-mentioned linear movement, for keeping the latch against the latching surface 7 of the swing handle arrangement in the locking position of the swing handle. In this context, the linear movement is described as the movement of the latch away from the latching surface of the swing handle, although it is obvious that its movement in the opposite direction is linear as well.

The tip part 12 of the latch comprises oblique surfaces 12A, 12B for moving the latch linearly away from and towards the frame 2 by turning the swing handle 1. The oblique surfaces are thus oblique to the longitudinal axis of the latch and to the direction of the linear movement of the same. Also, the latching surface 7 of the swing handle is correspondingly oblique. Thus, when the swing handle is lifted away from the frame 2, the oblique surfaces 7, 12A guide the latch 6 to move against the spring arrangement 11. In this context, the spring arrangement comprises two springs, but the number of springs may be different as well. When the swing handle 1 is moved back towards the frame 2, to be connected with it, the protrusion 7A presses the oblique surface 12B, whereby the latch 6 moves towards the spring arrangement 11. The latch is movable only when the cam 9 of the second shaft is not in the groove 10 of the latch.

The latch may comprise a protrusion 13 on one the side of the groove 10, namely on the side of the groove proximate to the tip part 12 of the latch. FIG. 8 shows the protrusion 13 in more detail, in a cross-sectional view of the latch 6. FIG. 8 shows that the plate 2A is provided with an opening 2C for the cam 9. Should the locking arrangement be tampered in any way to remove the cam 9 from the groove 10, the protrusion 13 tends to prevent the cam 9 from escaping from the groove.

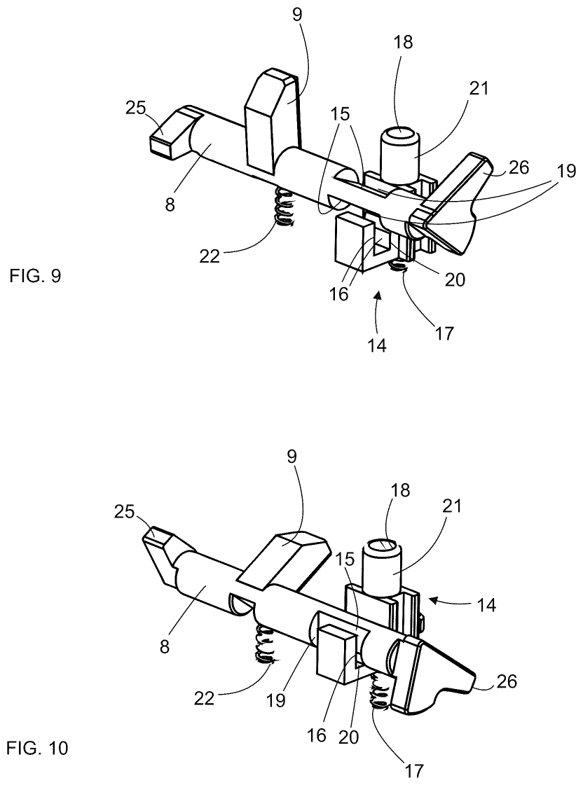

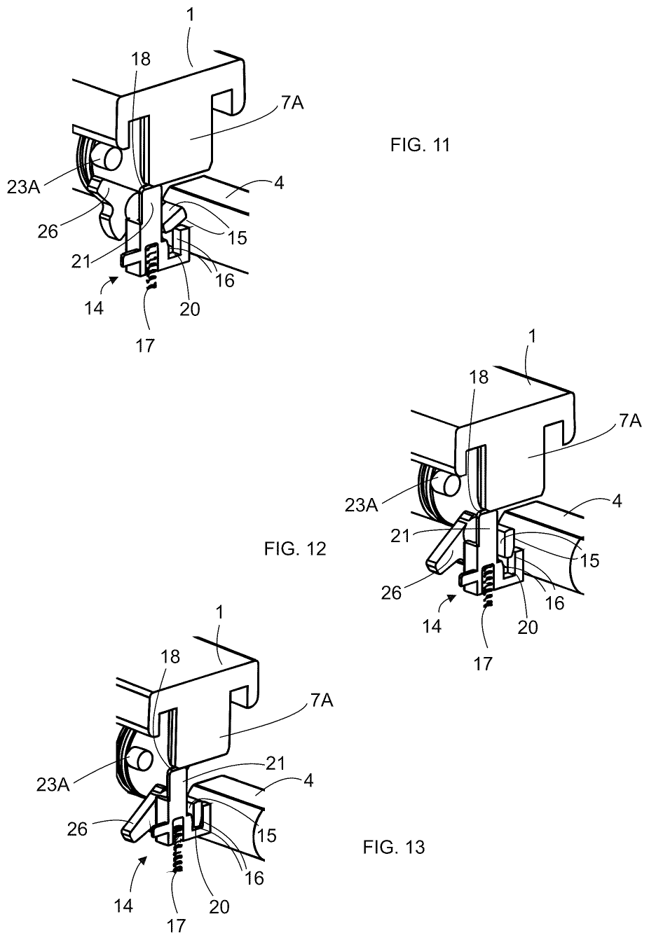

The swing handle arrangement may also comprise a locking element 14 for preventing, in its blocking position, the rotation of the second shaft 8. FIGS. 9 and 10 illustrate the operation of the locking element 14. FIGS. 11 to 13 also show the operation of the locking element, in cross-sectional views. The second shaft has a rotation barrier surface 15, and the locking element 14 comprises a counter-surface arrangement 16 arranged to be against the rotation barrier surface, in the blocking position of the locking element. In FIG. 9, the second shaft 8 is in the blocking position; that is, the cam 9 is in the groove 10 of the latch (not shown in FIG. 9). In FIG. 9, the locking element 14 is not in the blocking position. The swing handle arrangement thus also comprises a spring 17 for pushing the locking element 14 towards the blocking position. The locking element 14 further comprises a guide surface 18 for removing the locking element 14 from the blocking position when the swing handle 1 is being turned into its locking position. Thus, the protrusion 7A of the swing handle presses the guide surface 18, and the locking element 14 is moved into the position shown in FIG. 9. FIGS. 11 and 12 also show this position of the locking element.

FIG. 10 shows a situation in which the second shaft 8 has been turned by an electric actuator (or a lock cylinder) to a position in which the cam 9 is no longer in the groove 10 of the latch 6. Thus, the swing handle arrangement is no longer locked, but the swing handle can be lifted away from the frame 2. After the swing handle 1 has been lifted from the frame, for opening the door or hatch, the spring 17 pushes the locking element 14 towards the second shaft 8, wherein the counter-surface arrangement 16 of the locking element 14 is against the rotation barrier surface 15, preventing the second shaft 8 from rotating. Thus, the cam 9 cannot be turned to the blocking position, in which it would be received in the groove 10 of the latch 6. When the swing handle 1 is pressed back against the frame 2, the protrusion 7A of the swing handle presses the locking element via the guide surface 18 away from the blocking position, whereby the second shaft 8 can rotate so that the cam 9 will prevent the movement of the latch, that is, to the position shown in FIG. 9. The swing handle arrangement is thus locked. The figures show that the presented embodiment comprises a second spring 22 for turning the second shaft 8 towards a position in which the cam 9 is in the groove 10 of the latch.

In FIG. 11, the swing handle arrangement is locked, wherein the swing handle 1 is in connection with the frame 2, and its protrusion 7A is pressed against the guide surface 18. The second shaft 8 (shown partly in FIGS. 11 to 13) is in a position in which the cam 9 is in the groove 10 of the latch 6. In FIG. 12, the second shaft is turned by the electric actuator 4 into a position in which the cam 9 is not in the groove 10. Thus, the rotation barrier surface 15 of the second shaft, which in this embodiment comprises two surfaces, is in a position where the counter-surface arrangement 16 of the locking element 14 can move against the rotation barrier surface 15. In the situation of FIG. 12, the swing handle 1 is not yet lifted up, so it keeps the locking element off its blocking position.

The latch 6 keeps the swing handle 1 in connection with the frame 2, because the spring arrangement 11 pushes the latch towards the protrusion 7A and the locking surface 7. Thus, the swing handle 1 still remains in connection with the frame 2, although the arrangement is unlocked. This is advantageous, for example, in the daytime when locking is not desired. For taking the swing handle out from the frame, the user must pull the swing handle with a sufficient strength. This has the advantage that the swing handle arrangement can be arranged more freely in different positions on a door or a hatch without the swing handle spontaneously diverting from the frame (for example, installation in a horizontal plane or upside down with respect to the installation shown in FIG. 1).

In FIG. 13, the swing handle 1 has been lifted up, and the locking element 14 has been moved by the spring 17 towards the second shaft 8. Thus, the rotation barrier surface 15 of the shaft is against the counter-surface arrangement 16. In this position, the second shaft cannot be turned, and the cam 9 cannot be turned into the groove 10 of the latch. This prevents the locking of the latch in its blocking position, whereby the swing handle could not be turned back to the frame.

In the embodiments shown in the figures, the rotation barrier surface 15 comprises two surfaces, and the second shaft 8 has two notches 19 on opposite sides, the bottoms of the notches forming these two surfaces. The counter-surface arrangement 16 comprises a groove 20 whose sides are against the rotation barrier surface 15, in the blocking position of the locking element 14. Consequently, in this embodiment, the sides of the groove 20 constitute the counter-surfaces of the counter-surface arrangement 16.

In the second embodiment of the locking element 14, and its implementation, the second shaft 8 has a hole whose side surface or side surfaces constitute the rotation barrier surface 15, and the counter-surface arrangement 16 comprises a protrusion whose sides are against the rotation barrier surface 15, in the blocking position of the locking element 14.

The locking element 14 comprises a protrusion 21 whose end surface is the guide surface 18. The protrusion 21 may be, for example, a pin or a plate-like protrusion.

FIG. 6 shows a situation in which the arrangement is locked; that is, the cam 9 of the second shaft is in the groove 10 of the latch. As already mentioned above, the swing handle arrangement may also comprise a lock cylinder 23, 23C arranged to provide a connection to the second shaft 8 for turning it towards a position in which the cam 9 is off the groove 10 of the latch. The lock cylinder 23C shown in this figure has a body shape different from that in FIG. 3. Thus, the second shaft may also comprise a third cam 26, by which the lock cylinder 23 is arranged to form a link to the second shaft 8 for turning it towards a position in which the cam 9 is off the groove 10 of the latch. This situation is shown in FIG. 7, in which the second shaft has been rotated by applying the lock cylinder. For example, the lock cylinder has a protrusion 23A which is turned by turning a key (or an electric actuator). The turnable protrusion 23A, in turn, turns the second shaft 8, for example, via a third cam 26, as is shown in the embodiment of the figures.

The control of the electric actuator to the second shaft can be implemented, for example, as shown in the figures. In the embodiment shown in the figures, the shaft arrangement 5 of the electric actuator comprises a lever 24, and the second shaft 8 comprises a second cam 25. The lever and the second cam are arranged to form a link between each other for turning the second shaft by means of the electric actuator. FIG. 4 shows a situation in which the arrangement is locked, the cam 9 being received in the groove 10 of the latch 6. For unlocking, the electric actuator 4 turns the shaft arrangement 5 and simultaneously the lever 24. The lever 24, in turn, rotates the second shaft 8 via the second cam 25, whereby the cam 9 comes out of the groove 10 of the latch and, simultaneously, the swing handle arrangement is unlocked.

The electric actuator 4 is an electric motor, but it may be a solenoid actuator as well. If a solenoid actuator is applied, the shaft arrangement 5 of the actuator comprises a mechanism for turning the lever 24.

Thanks to the invention, a swing handle arrangement with a locking function can be installed more freely in a door or a hatch so that daytime use is possible, and the swing handle remains in connection with the frame also during daytime use. Thus, the swing handle is not diverted from the frame without pulling the swing handle off the frame. That is, the swing handle is not diverted by gravity or strong wind during daytime use.

Furthermore, the electric actuator and the lock cylinder can be returned to their initial position, in which they do not tend to turn the second shaft 8 immediately after unlocking the swing handle arrangement, when the locking element 14 is used. The arrangement according to the invention also makes it possible to turn the swing handle 1 back to the frame 2 without the latch 6 forming a barrier.

In the light of the examples presented above, it is obvious that an implementation according to the invention can be achieved by a variety of solutions. In other words, the invention can be implemented with many different embodiments within the scope of the independent claim.

1. A swing handle arrangement with a locking function, comprising:
a frame;
a spindle arrangement connected to the frame in a pivotable manner;
a swing handle connected to the spindle arrangement in a pivotable manner, the swing handle comprising a latching surface;
an electric actuator;
a shaft arrangement of the electric actuator;
a latch set in the frame and arranged to be against the latching surface of the swing handle in a locking position of the swing handle, wherein the latch and the latching surface are thus arranged to establish the locking of the swing handle arrangement, which locking is releasable by the electric actuator via the shaft arrangement of the electric actuator; and
a second shaft with a cam,
wherein the latch has a groove,
wherein, in the locking position of the swing handle arrangement, the cam is in the groove, preventing a linear movement of the latch away from the latching surface of the swing handle, and
wherein the locking is releasable by the electric actuator via the shaft arrangement of the electric actuator, by turning the second shaft so that the cam moves out of the groove.

2. The swing handle arrangement according to claim 1, further comprising a spring arrangement to push the latch in a direction opposite to said linear movement, in order to keep the latch against the latching surface of the swing handle arrangement in the locking position of the swing handle, and wherein a tip part of the latch comprises oblique surfaces in order to move the latch linearly away from and towards the frame by turning the swing handle.

3. The swing handle arrangement according to claim 1, wherein the latch comprises a protrusion by the side of the groove, on the side of the groove proximate to the tip part of the latch.

4. The swing handle arrangement according to claim 1, further comprising a locking element to prevent, in its blocking position, the rotation of the second shaft,
wherein the second shaft has a rotation barrier surface,
wherein the locking element comprises a counter-surface arrangement arranged to be against the rotation barrier surface in the blocking position of the locking element,
wherein the swing handle arrangement comprises a spring for pushing the locking element towards the blocking position, and
wherein the locking element further comprises a guide surface to move the locking element away from the blocking position when the swing handle is being turned into its locking position.

5. The swing handle arrangement according to claim 4, wherein the rotation barrier surface comprises two surfaces, and the second shaft comprises two notches on opposite sides, the bottoms of the notches forming these two surfaces, and the counter-surface arrangement comprises a groove whose sides are against the rotation barrier surface in the blocking position of the locking element.

6. The swing handle arrangement according to claim 4, wherein the second shaft comprises a hole whose side surface or side surfaces constitute the rotation barrier surface, and the counter-surface arrangement comprises a protrusion whose sides are against the rotation barrier surface in the blocking position of the locking element.

7. The swing handle arrangement according to claim 4, wherein the locking element comprises a protrusion whose end surface is the guide surface.

8. The swing handle arrangement according to claim 1, further comprising a second spring to turn the second shaft towards a position in which the cam is in the groove of the latch.

9. The swing handle arrangement according to a, claim 1, further comprising a lock cylinder arranged to provide a link to the second shaft in order to turn it towards a position in which the cam is off the groove of the latch.

10. The swing handle arrangement according to claim 1, wherein the shaft arrangement of the electric actuator comprises a lever, and the second shaft comprises a second cam, and
wherein the lever and the second cam are arranged to form a link to each other in order turn the second shaft by means of the electric actuator.

11. The swing handle arrangement according to claim 10, wherein the second shaft comprises a third cam, by which the lock cylinder is arranged to form a link to the second shaft in order to turn it towards a position in which the cam is off the groove of the latch.
